(19) United States
(12) Patent Application Publication
(10) Pub. No.: US 2025/0248570 A1
(43) Pub. Date: Aug. 7, 2025

(54) SHAKER CUP

(71) Applicant: Starbucks Corporation, Seattle, WA (US)

(72) Inventor: Jonathan Levey, Geneseo, NY (US)

(21) Appl. No.: 19/044,283

(22) Filed: Feb. 3, 2025

Related U.S. Application Data
(60) Provisional application No. 63/550,911, filed on Feb. 7, 2024.

(51) Int. Cl. A47J 43/27; A47J 31/44; B65D 1/26

(52) U.S. Cl. CPC A47J 43/27; A47J 31/4496; B65D 1/265

(57) ABSTRACT

Generally described, one or more aspects of the present disclosure relate to methods, systems, and devices related to a shaker cup and serving cup assembly including a shaker cup, a first serving cup of a first size and a second serving cup of a second size. The shaker cup having a body defining a first interior, a rim defining an opening, a first ridge of a first ridge diameter positioned below the rim, and a second ridge of a second ridge diameter positioned below the first ridge, The first ridge diameter is larger than the second ridge diameter. The first ridge of the shaker cup is configured to receive the first serving cup, and the second ridge of the shaker cup is configured to receive the second serving cup.

### INCORPORATION BY REFERENCE TO ANY PRIORITY APPLICATIONS

This application claims priority to U.S. Provisional Patent Application No. 63/550,911, filed Feb. 7, 2024, the entirety of which is incorporated herein by reference.

### FIELD

The present disclosure relates to systems and methods for preparing a beverage, such as, in certain embodiments, systems and methods for preparing a shaken beverage using a shaker cup.

### DESCRIPTION OF THE CERTAIN RELATED ART

Certain beverages are prepared by shaking, which can be executed in a cup with a lid. The beverage can be poured into a cup, the vessel can be closed, such as with a lid. The closed vessel can be shaken to shake the beverage. Shaking the beverage can incorporate all ingredients to create a more homogenous beverage. In some processes, ice is added to the beverage and shaking the beverage can more quickly lower the temperature of the beverage. In some processes, shaking the beverage can create frothiness in the beverage.

### SUMMARY

The systems, methods and devices of this disclosure each have several innovative aspects, no single one of which is solely responsible for the desirable attributes disclosed herein.

A shaker cup can include a body defining a first interior, a rim defining an opening, a first ridge of a first ridge diameter positioned below the rim, the first ridge configured to receive a first serving cup of a first size, and a second ridge of a second ridge diameter positioned below the first ridge, the second ridge configured to receive a second serving cup of a second size. The first ridge diameter can be larger than the second ridge diameter.

In some configurations, the first ridge can include a first planar surface that is concentric to the rim, and the second ridge can include a second planar surface that is concentric to the first ridge. In some configurations, the shaker cup can include a first sidewall positioned between the rim and the first ridge and a second sidewall positioned between the first ridge and the second ridge. In some configurations, the first planar surface of the first ridge can be configured to extend at a first angle relative to the first sidewall, and the second planar surface of the second ridge can be configured to extend at a second angle relative to the second sidewall, and the first angle and the second angle can each be between 90 degrees to 145 degrees. In some configurations, the first sidewall can be configured to form a first radial seal with the first serving cup, and the second sidewall can be configured to form a second radial seal with the second serving cup. In some configurations, the first planar surface can be configured to form a first face seal with the first serving cup, and the second planar surface can be configured to form a second face seal with the second serving cup. In some configurations, the first ridge diameter of the first ridge can be configured to receive a first cup diameter of the first serving cup. In some configurations, the second ridge diameter of the second ridge can be configured to receive a second cup diameter of the second serving cup. In some configurations, the first ridge and the second ridge can be configured to form a stepped profile. In some configurations, the shaker cup can include a third ridge of a third ridge diameter positioned below the second ridge, and the third ridge diameter can be smaller than the second ridge diameter of the second ridge. In some configurations, the rim can include a lip that extends radially such that the lip defines an outer circumferential edge of the opening of the shaker cup.

In another aspect, a shaker cup and serving cup assembly can include a shaker cup, a first serving cup of a first size, and a second serving cup of a second size. The shaker cup can include a body defining a first interior, a rim defining an opening, a first ridge of a first ridge diameter positioned below the rim, and a second ridge of a second ridge diameter positioned below the first ridge. The first ridge diameter can be larger than the second ridge diameter. The first size and the second size can be different. The first ridge of the shaker cup can be configured to receive the first serving cup and the second ridge of the shaker cup can be configured to receive the second serving cup.

In some configurations, the first serving cup can be configured to be inverted such that an open end of the first serving cup can be positioned below a closed end of the first serving cup when the first serving cup is received by the shaker cup. In some configurations, the shaker cup can include a first material, and the first serving cup and the second serving cup can include a second material. The first material can be more rigid than the second material. In some configurations, the first ridge can include a first planar surface that is concentric to the rim, and the second ridge can include a second planar surface that is concentric to the first ridge. In some configurations, a planar surface of a rim of the first serving cup can be configured to be positioned against the first planar surface of the first ridge of the shaker cup when the shaker cup receives the first serving cup, and a planar surface of a rim of the second serving cup can be configured to be positioned against the second planar surface of the second ridge of the shaker cup when the shaker cup receives the second serving cup. In some configurations, the shaker cup can include a first sidewall positioned between the rim and the first ridge, and the shaker cup can include a second sidewall positioned between the first ridge and the second ridge. In some configurations, an outer circumferential surface of a rim of the first serving cup can be configured to form a first radial seal with the first sidewall when the shaker cup receives the first serving cup, and an outer circumferential surface of a rim of the second serving cup can be configured to form a second radial seal of the second sidewall when the shaker cup receives the second serving cup. In some configurations, a longitudinal axis of the shaker cup and a longitudinal axis of the first or second serving cup can be configured to be aligned. In some configurations, the rim can include a lip that extends radially such that the lip defines an outer circumferential edge of the opening of the shaker cup.

In another aspect, a shaker cup and lid assembly can include a shaker cup and a lid. The shaker cup can include a body defining a first interior, a rim defining an opening, a first ridge of a first ridge diameter positioned below the rim, and a second ridge of a second diameter positioned below the first ridge. The first ridge diameter can be larger than the second ridge diameter. The lid can include a handle and a base. The base can include a projection extending radially from an outer circumferential surface of the base and a distal end extending distally from the projection.

In some configurations, the distal end of the base can be configured to fit within the opening of the shaker cup to form a seal. In some configurations, an outer circumferential surface of the distal end of the base can form a radial seal with an inner surface of the opening of the shaker cup. In some configurations, the rim can include a lip that extends radially such that the lip defines an outer circumferential edge of the opening of the shaker cup. In some configurations, a distal surface of the projection can be configured to form a face seal with a top surface of the lip of the shaker cup.

A method for shaking a beverage can include placing one or more ingredients in a shaker cup, positioning a serving cup on top of the shaker cup to seal the shaker cup, wherein the serving cup is less rigid than the shaker cup, shaking the shaker cup and the serving cup together, removing the shaker cup from the serving cup, and serving the beverage in the serving cup.

In some aspects, the beverage is a tea or coffee beverage. In some aspects, the shaker cup comprises plastic, glass, or metal. In some aspects, the serving cup comprises plastic or paper.

A method for preparing a beverage can include placing one or more ingredients in a shaker cup, positioning a first serving cup of a first size or a second serving cup of a second size on top of the shaker cup to seal the shaker cup, wherein the first size is different from the second size, shaking the shaker cup and the first or second serving cup together, removing the shaker cup from the first or second serving cup, and serving the beverage in the first or second serving cup.

In some aspects, the method includes positioning the first serving cup in an inverted position when the first serving cup is received by the shaker cup, where, in the inverted position, an open end of the serving cup is positioned beneath a closed end of the serving cup. In some aspects, shaking the shaker cup and the first or second serving cup together includes positioning the shaker cup in an upright position and the first or second serving cup in an inverted position. In some aspects, the method can include inverting the shaker cup and the first or second serving cup together such that the shaker cup is in an inverted position and the first or second serving cup is in an upright position. In some aspects, the method further includes placing a lid on the first or second serving cup. In some aspects, shaking the shaker cup and the first or second serving cup together comprises forming a foam head with a height between 0.25 inches to 2 inches.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 illustrates an embodiment of a shaker cup.

FIG. 2 illustrates a side view of the shaker cup of FIG. 1.

FIG. 3 illustrates a cross-sectional view of the shaker cup of FIG. 1.

FIG. 4 illustrates a shaker cup and beverage cup assembly.

FIG. 5 illustrates the shaker cup with two beverage cups.

FIG. 6 illustrates a close up view of a portion of FIG. 5.

FIG. 7 illustrates another embodiment of a shaker cup.

FIG. 8 illustrates a side view of the shaker cup of FIG. 7.

FIG. 9 illustrates a shaker cup and beverage cup assembly.

FIG. 10 illustrates a lid for a shaker cup.

FIG. 11 illustrates a cross-sectional view of the lid of FIG. 10.

FIG. 12 illustrates a cross-sectional view of the lid and shaker cup assembly.

FIG. 13 illustrates a close up view of a portion of FIG. 12.

### DETAILED DESCRIPTION

Various beverage preparation systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown but is instead to be accorded the widest scope consistent with the principles and features that are disclosed or suggested herein. For example, many of the embodiments are described in the context of preparing a beverage including shaking. However, certain features and aspects of the disclosure may also have utility in preparing other liquids, such as sauces or dressing.

The process of shaking a beverage can be time consuming and inefficient. The process can include placing the ingredients into a vessel. The vessel may then be closed before the vessel is shaken. The vessel can be sealed when closed to prevent leaking of the beverage from the vessel during shaking. The sealing process can be ineffective or unreliable. After shaking, the vessel can be opened. The beverage can then be transferred from the vessel into a container for serving the beverage.

There is a need for an improved beverage shaker assembly. Beverage shaker assemblies generally use two shaker cups to prepare and shake a beverage. Beverage shaker assemblies can be messy and require frequent cleaning of the shaker assembly as well as preparation surfaces due to leaking seals between the shaker cups. The beverage shaker assemblies can also be inefficient in preparing beverages because the shaker assemblies may not be appropriately sized for the beverage being prepared. This can lead to preparing a greater quantity of the beverage than was ordered. Additional inefficiencies occur when transferring a shaken beverage from the shaker assembly into a serving cup.

The following description is directed towards an improved beverage preparation system. The improved beverage shaker assembly can form a watertight seal with various sizes of serving cups. This can allow a beverage placed within the shaker assembly to be thoroughly mixed without spilling the beverage. Additionally, the improved beverage shaker assembly can utilize a serving cup to shake the beverage. The efficiency of beverage preparation is improved by using a serving cup to shake the beverage by removing the step of transferring the shaken beverage from the shaker assembly into the serving cup. This can reduce the time required to make the beverage, remove the spill risk of transferring the beverage from the shaker assembly into the serving cup, and reduce the number of shaker assembly components requiring cleaning between uses. Additionally, the use of the improved shaker assembly can also increase beverage preparation efficiency by producing accurate beverage volume yields by shaking the beverage with an appropriately sized serving cup while simultaneously producing a well shaken beverage.

The shaker assembly may also be equipped with a lid which can form a watertight seal with the shaker assembly. This can advantageously allow for flexibility in preparing beverages that may be served in re-usable containers, for example, if a customer brings in their own reusable serving cup.

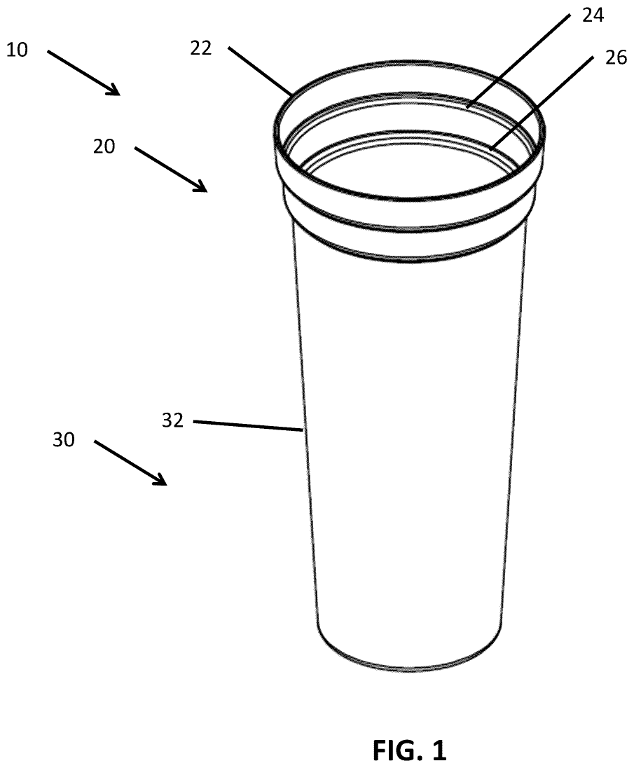

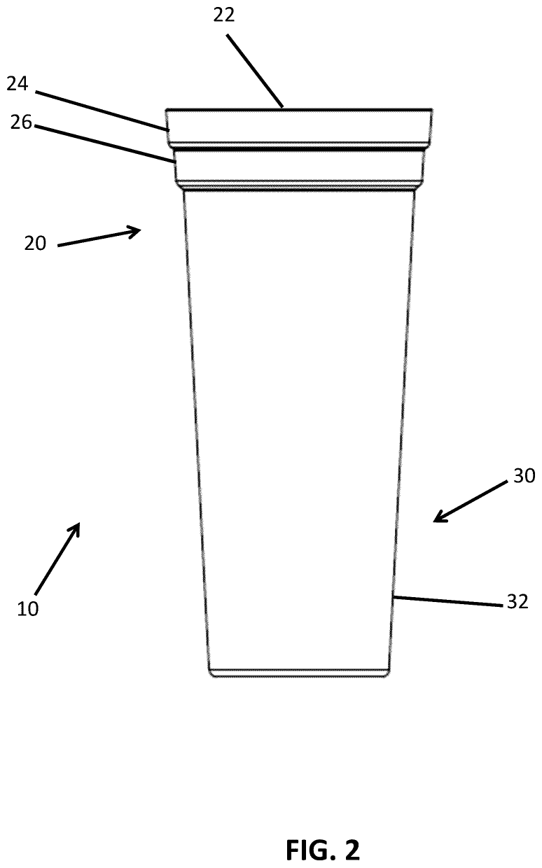

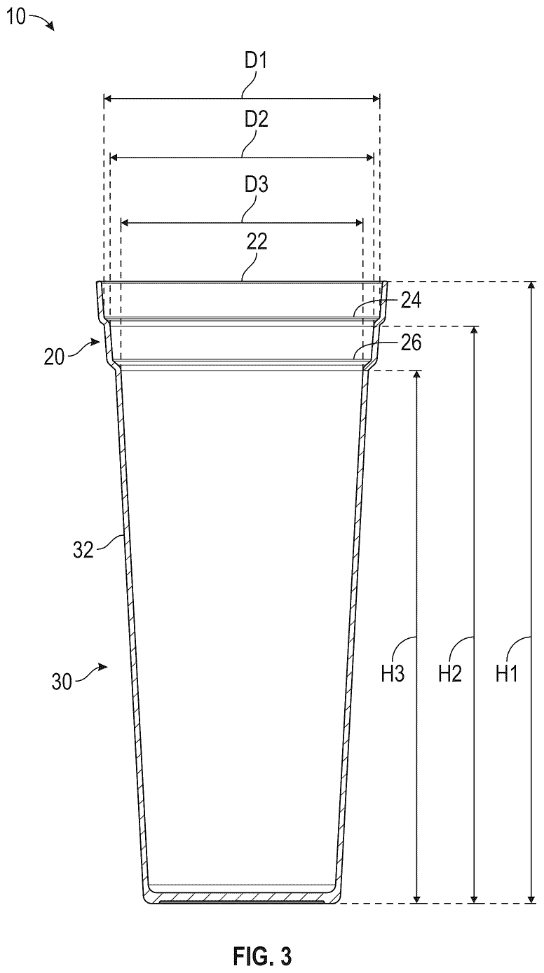

FIGS. 1-3 illustrate a shaker cup 10 for a shaker cup and cup assembly. The shaker cup 10 can be configured to engage with multiple cup sizes. The shaker cup 10 can be configured to engage with a drinking cup. This advantageously allows the beverage to be shaken in the same cup for serving and drinking. The serving cup can act to seal the shaker cup 10 and the assembly can be shaken to shake the beverage. In other examples, the shaker cup 10 can seal the serving cup. Once the beverage is shaken in the assembly, the beverage can be positioned in the serving cup. The shaker cup 10 can then be removed from the serving cup and replaced with a lid for drinking. This can advantageously beverage to be shaken and served in the same cup.

The shaker cup 10 can include a top portion 20 and a bottom portion 30. The body 32 of the cup 10 can be at the bottom portion 30 of the cup 10. The rim 22 of the cup 10 can be at the top portion 20 of the cup 10. The rim 22 can define the opening of the cup 10. The shaker cup 10 can include a series of ridges of various sizes at the top portion 20 of the cup 10. The ridges can be a series of concentric ridges. As shown in FIGS. 1-3, the cup 10 can include two ridges 24, 26 of different diameters and at different levels along the length of the cup. The two ridges can include a first ridge 24 and a second ridge 26. Each ridge 24, 26 can each be a planar surface. The first ridge 24 and the second ridge 26 can be concentric planar surfaces. The rim 22, the first ridge 24, and the second ridge 26 can be concentric to one another.

The inner diameter of each ridge 24, 26 and the rim 22 can decrease in a vertical direction, from the top end towards the bottom end of the cup 10. The rim 22 can have the largest inner diameter compared to the inner diameter of the first ridge 24 and the inner diameter of the second ridge 26. The first ridge 24, positioned between the second ridge 26 and the rim 22, can have a smaller inner diameter than the inner diameter of the rim 22. The second ridge 26 can have the smallest inner diameter compared to the inner diameter of the rim 22 and the inner diameter of the first ridge 24. In this manner, the rim 22, the first ridge 24, and the second ridge 26 can form a stepped profile. The stepped profile can decrease in size along the length of the cup from the open end towards the closed end. As shown in FIGS. 1-3, the body 32 can be tapered such that the diameter changes throughout the length of the body 32. The ridges 24 and 26 can be molded into the inner surface of the body 32 forming a stepped profile and the outer surface of the body 32 can have a smooth profile with a constant slope. As shown in FIGS. 1-3 the ridges 24 and 26 can be molded into the body 32 forming a stepped profile in both the inner surface and the outer surface of the body 32. The body 32 can include constant or nearly constant wall thickness throughout the cup 10. The body 32 can include varied wall thicknesses throughout the cup 10. The wall thickness of the body 32 can decrease from the second ridge 26 to the first ridge 24. As shown in FIGS. 1-3, the inner diameter of the body 32 can decrease in a vertical direction, from the top end towards the bottom end of the cup 10. In other examples, the inner diameter of the body 32 can increase in a vertical direction, from the top end towards the bottom end. In other examples, the body 32 can be cylindrical such that the diameter is consistent throughout the length of the body 32. As shown in FIGS. 1-3, the largest inner diameter of the body 32 can be at the top of the body 32. The largest diameter of the body 32 can be the same or smaller than the inner diameter of the second ridge 26.

In some examples, the rim 22 can have an inner diameter D1. D1 can be between 4 inches to 5 inches, and in some embodiments between 4.0 inches to 4.2 inches. The first ridge 24 can have an inner diameter D2. D2 can be between 3 inches to 4 inches, and in some embodiments between 3.5 inches to 4 inches. The second ridge 26 can have an inner diameter D3. D3 can be between 3 inches to 4 inches, and in some embodiments between 3.4 inches to 3.8 inches. The body 30 can slope outward from D3 to D2 and from D2 to D3. The outward slope from D3 to D2 can be between 1 and 6 degrees, and in some embodiments between 3 and 4 degrees. The outward slope from D2 to D1 can be between 1 and 6 degrees, and in some embodiments between 3 and 4 degrees. The first ridge 24 can be extend inward at an angle between 115 and 160 degrees from the slope of the wall to form the ridge 24 and reduce the inner diameter from D1 to D2. The second ridge 26 can be extend inward at an angle between 115 and 160 degrees from the slope of the wall to form the ridge 26 and reduce the inner diameter from D2 to D3. In some examples, the inner diameter of the top portion of the body 32 can be between 3 inches to 4 inches, and in some embodiments between 3.5 inches to 4 inches. The shaker cup 10 can have a total height of H1. H1 can be between 8 inches to 10 inches, such as between 9 inches to 9.5 inches. The shaker cup 10 can have a height H2 from the bottom of the first ridge 24 to the bottom of the cup 10. H2 can be between 7.5 inches to 9.5 inches, such as between 9 inches and 8 inches. The shaker cup 10 can have a height H3 from the bottom of the second ridge 26 to the bottom of the cup 10. H3 can be between 7 inches to 9 inches, such as between 8.5 inches and 7.75 inches.

In some examples, the overall length or height of the shaker cup 10 can be between 6 inches to 9 inches, and in some embodiments between 8 inches and 9 inches. In some examples, the height or length of the shaker cup 10 can be between 8 inches and 8.5 inches.

In other examples, the cup 10 can include at least two ridges of various diameters. In some examples, the cup 10 can include 1, 3, 4, 5, or more ridges of various diameters. Each ridge having a different diameter, which can advantageously allow the shaker cup 10 to receive a variety of serving cups of different sizes. Specifically, the shaker cup 10 can fit a variety of diameters of serving cup openings. The number of ridges of the shaker cup 10 can correspond to the number of sizes of cups that the shaker cup 10 can engage with. For example, the illustrated shaker cup 10 in FIGS. 1-3 has two ridges and is therefore configured to fit with two sizes of openings of serving cups. In another example, a shaker cup having three ridges may be configured to fit with three sizes of openings of serving cups. Serving cups having different volumes may have the same size opening. For example, a serving cup with a larger volume may have a larger diameter opening and a serving cup with a smaller volume may have a smaller diameter opening. Serving cups having different volumes may have the same diameter opening. In some examples, a shaker cup having two ridges may be configured to fit with 2, 3, 4, 5, or 6 different volumes of serving cups.

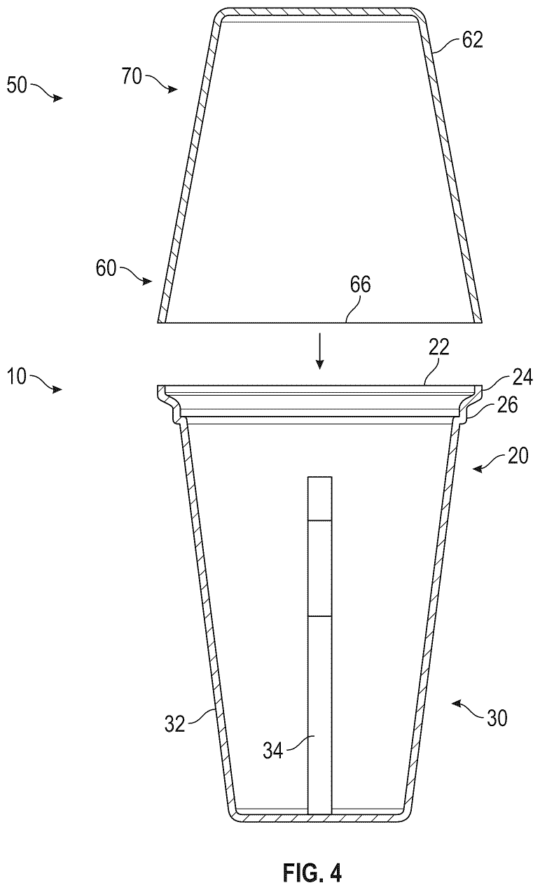

FIG. 4 illustrates an embodiment of a shaker cup 10 and serving cup 50 assembly. The shaker cup 10 can be configured to receive a serving cup 50. The shaker cup 10 can be similar to the shaker cup 10 shown in FIG. 1, except for the window 34. As shown in FIG. 4, the body 32 of the shaker cup 10 can include a window 34 that allows a user to see a level of liquid positioned within the shaker cup 10. The window 34 can include one or more markers that show measurements of liquid within the cup 10. As shown in FIG. 4, the shaker cup 10 can be configured to receive a serving cup 50. The serving cup 50 can be inverted such that the open end is facing downward or such that the open end at the first portion 60 is positioned at the bottom and the closed end at the second portion 70 is positioned at the top. The open end 60 of the serving cup 50 can be positioned adjacent to the top portion 20 of the shaker cup 10. The rim 66 of the open end of the serving cup 50 can be positioned against the one of the first ridge 24 or the second ridge 26 of the shaker cup 10. This can allow the serving cup 50 and the shaker cup 10 to form a seal. The body 32 of the shaker cup 10 can define a first interior or cavity. The body 62 of the serving cup 50 can define a second interior or cavity. When the serving cup 50 and shaker cup 10 are engaged to form a seal, the first interior of the shaker cup 10 and the second interior of the serving cup 50. This can allow the interior of the shaker cup 10 and the interior of the serving cup 50 to form an enclosed interior. The beverage can be shaken within the enclosed interior.

The enclosed interior provided between the components can be sized and shaped to allow for significant turbulence of the contents positioned within the enclosed interior. Due to the size of the enclosed interior, the user can fully shake the assembly to shake the beverage. This can provide more efficient mixing of the beverage over swirling or mixing. The enclosed interior can also advantageously allow the beverage to be shaken efficiently such that the time and effort required to shake the beverage is reduced. In some examples, the shaker cup 10 can have a height H1 between 8 inches to 12 inches, and in some examples between 9 inches to 10 inches. In some examples, the shaker cup 10 can have a maximum width or diameter D1 of 3 inches to 6 inches, and in some examples between 4 inches to 5 inches. In some examples, the turbulence achieved only requires between 3 to 5 shakes to achieve adequate mixing of the beverage such that a frothy top layer is formed on the beverage. In some examples, the shaken beverage has a foam head or layer of at least between 0.25 inches and 2 inches in height. The use of shaker cup 10 as described herein to prepare a beverage is particularly useful to prepare a tea or coffee beverage (that is, a beverage formed, at least in part, from coffee or tea component).

In some examples, the shaker cup 10 can include a gasket on an upper surface of the ridges. The gasket can seal the rim 66 of the serving cup 50 and the corresponding ridge 24, 26 of the shaker cup 10. The gasket can be made of silicone or any soft material that can facilitate sealing. In some examples, the shaker cup 10 can exclude the silicone gasket such that the ridges 24, 26 are made of the same material as the remainder of the cup 10 and directly contact the rim 66 of the serving cup 50.

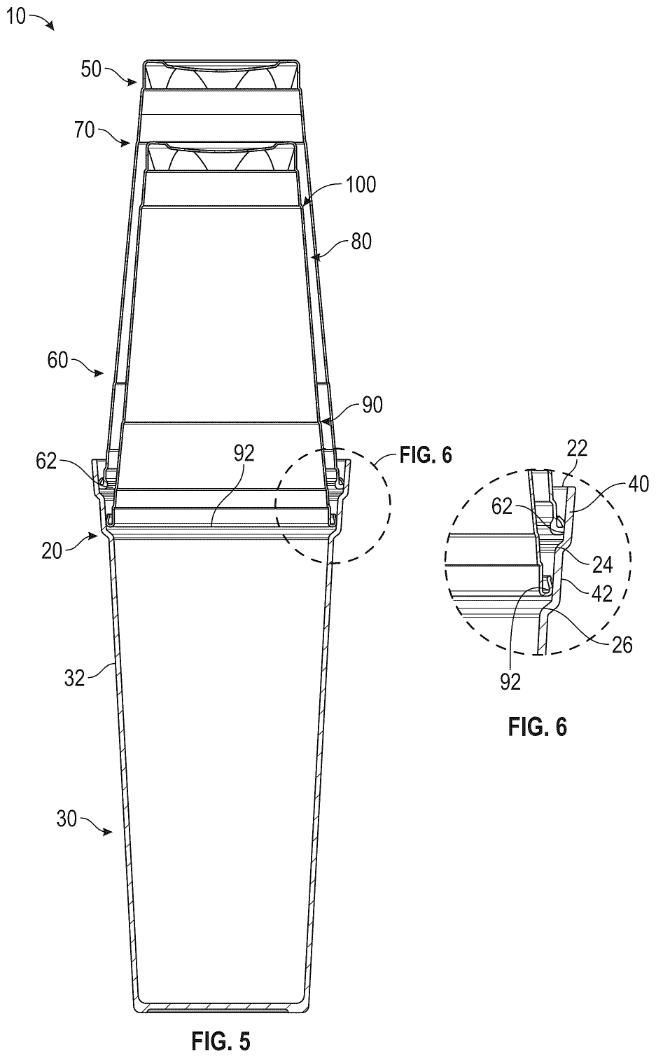

FIG. 5 illustrates the shaker cup 10 receiving two serving cups 50, 80. FIG. 6 illustrates a close up view of a portion of the two serving cups 50, 80 each engaged by a portion of the shaker cup 10. The shaker cup 10 can be configured to receive two different sizes of serving cups 50, 80. Although the shaker cup 10 in FIGS. 5 and 6 is shown with two serving cups 50, 80, the shaker cup 10 can be used with only one of the serving cups 50, 80. The second serving cup 80 can have a first open end 90 and a second closed end 100. The second serving cup can have a rim 92 at the first open end 90. The rim 62 of the first cup 50 can be received and engage with the first ridge 24 of the shaker cup 10. The rim 92 of the second cup 80 can be received and engage with the second ridge 26 of the shaker cup 10. The rim 62 of the first serving cup 50 can have a similar outer diameter to the diameter of the first ridge 24. The rim 92 of the second serving cup 80 can have a similar diameter to the diameter of the second ridge 26. The diameter of the rim 62 of the first serving cup 50 can be larger than the diameter of the rim 92 of the second serving cup 80.

The ingredients for a beverage can be positioned in the interior of the shaker cup 10. One of the serving cups 50, 80 can be affixed to a top of the shaker cup 10 to create a seal. In some examples, the first serving cup 50 can be affixed to a top of the shaker cup 10 and positioned against the first ridge 24 of the shaker cup 10. When sealed, the interior of the shaker cup 10 and the interior of the serving cup 50 can together define an interior enclosed space. The assembly of the shaker cup 10 and the serving cup 50 can be shaken together to move and mix the beverage within the interior enclosed space. While shaking, the shaker cup 10 can remain in a substantially upright position and the serving cup 50, 80 can be in a substantially upside-down position. While shaking, the shaker cup 10 and the serving cup 50, 80 can be in a substantially horizontal position. Once shaken, the shaker cup 10 and serving cup 50, 80 can be inverted such that the shaker cup 10 is at the top in an upside-down position and the serving cup 50, 80 is on the bottom in an upright position. In the upright position, the serving cup 50 can be positioned such that the closed end 50 can be positioned beneath the open end 60. The shaker cup 10 can then be removed from the serving cup 50. The serving cup 50 with the shaken beverage positioned therein can then be served to a customer.

The diameter of each of the ridges 24, 26 can be configured to receive a rim of a serving cup of a respective size. The step profile of the ridges 24, 26 and the rim 22 advantageously provides both a face seal and a radial seal. For example, as shown in FIG. 6, when the first ridge 24 receives the first cup 50 of a corresponding diameter, the planar surface of the first ridge 24 can form a face seal with the top or planar surface of the rim 62 of the serving cup. Simultaneously, the inner circumferential surface of the rim 22 can form a radial seal with the outer circumferential surface of the rim 62 of the serving cup 50. The inner surface of the first sidewall 40 can form a radial seal with the outer circumferential surface of the rim of the first serving cup 50. The inner surface of the second sidewall 42 can form a radial seal with the outer circumferential surface of the rim of the second serving cup 80. Similarly, the second ridge 26 can receive the second serving cup 80 such that the second ridge 26 provides both a radial seal and a face seal between the second serving cup 80 and the shaker cup 10.

As shown in the cross-sectional view illustrated in FIG. 6, the first ridge 24 and the second ridge 26 can be a concentric planar surface that extends substantially perpendicular to the inner surface of the sidewalls of the shaker cup 10. A first sidewall 40 can extend between a rim 22 and the ridge 24. A second sidewall 42 can extend between the first ridge 24 and the second ridge 26. In some examples, the first ridge 24 can be positioned at a first angle relative to the first sidewall 40 and the second ridge 26 can be positioned at a second angle relative to the second sidewall 42. In some examples, the first and second angles can each be at least 90 degrees. In some examples, the first and second angles can each be at least 100 degrees, 110 degrees, 120 degrees, or 130 degrees. In some examples, the first and second angles can each be between 90 degrees to 145 degrees and in some embodiments between 115degrees to 145 degrees. In some examples, the first and second angles can advantageously allow the first and second sidewalls 40, 42 to provide a radial seal to the respective serving cup while still enabling the respective serving cup to easily fit within the first and second sidewalls 40, 42. The shaker cup 10 and the serving cup 50, 80 be assembly quickly in this manner. The shaker cup 10 and the serving cup 50, 80 can also be assembled such that the longitudinal axis of each of the shaker cup 10 and the serving cup are aligned, such that neither component is tilted. The shaker cup 10 can contact the respective serving cup with adequate friction and support to maintain the assembly with only the user holding both components together while shaking. The shaker cup 10 and the serving cup can be assembled to form a vacuum to facilitate the seal between the shaker cup 10 and the serving cup 50, 80. The user is not required to tilt either component or to forcefully slam the shaker cup 10 and the respective serving cup together to form a seal.

The shaker cup 10 can include a rigid material, such as a hard plastic, glass, or metal. The shaker cup 10 can be substantially made of the rigid material. The shaker cup 10 can be reusable and resilient to withstand repeated use and cleaning. The shaker cup 10 can also be resilient to temperature variations and maintain its shape in high and low temperature environments. The serving cup 50, 80 can include less rigid materials, such as thinner or softer plastic or paper, or thin-walled metal. The serving cup 50, 80 can be substantially made of the less rigid material. The serving cup 50, 80 can be less rigid than the shaker cup 10. The serving cup 50, 80 can be a disposable cup and/or a single use cup. The serving cup 50, 80 may be a reusable cup. Due to the shape, size, and rigidity of the shaker cup 10 as described herein, the shaker cup 10 can advantageously be used with serving cups 50, 80 that are less rigid. The shaker cup 10 can be resilient, allowing the diameter of the shaker cup 10 to deform when squeezed. The serving cups 50, 80 may be resilient, allowing the diameter of the serving cup 50, 80 to deform when squeezed. The serving cups 50, 80 may deform with less force than the shaker cup 10. Advantageously, the serving cups 50, 80 may be squeezed to deform and release the seal between the serving cups 50, 80 and the shaker cup 10. As described herein, this allows the beverage to be prepared and shaken in the serving cup 50, 80 with the shaker cup 10 and then served in the same serving cup 50, 80. This reduces the number of steps required, time and number of components to prepare a beverage. The use of hard plastic can also advantageously prevent the shaker cup 10 from overheating. This advantageously allows the shaker cup 10 to be used with hot or warm beverages without causing discomfort or injury to the user holding the shaker cup 10. The use of hard plastic can also advantageously prevent the shaker cup 10 from becoming too cold. This advantageously allows the shaker cup 10 to be used with iced beverages without causing discomfort or injury to the user holding the shaker cup 10.

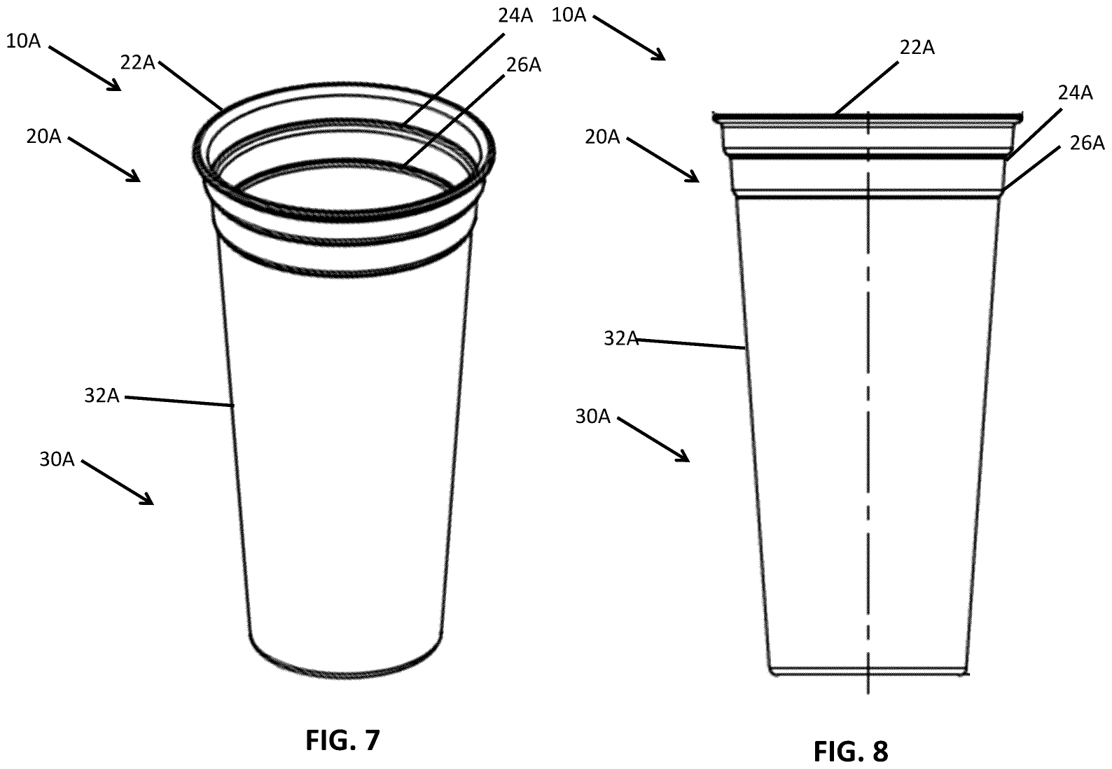

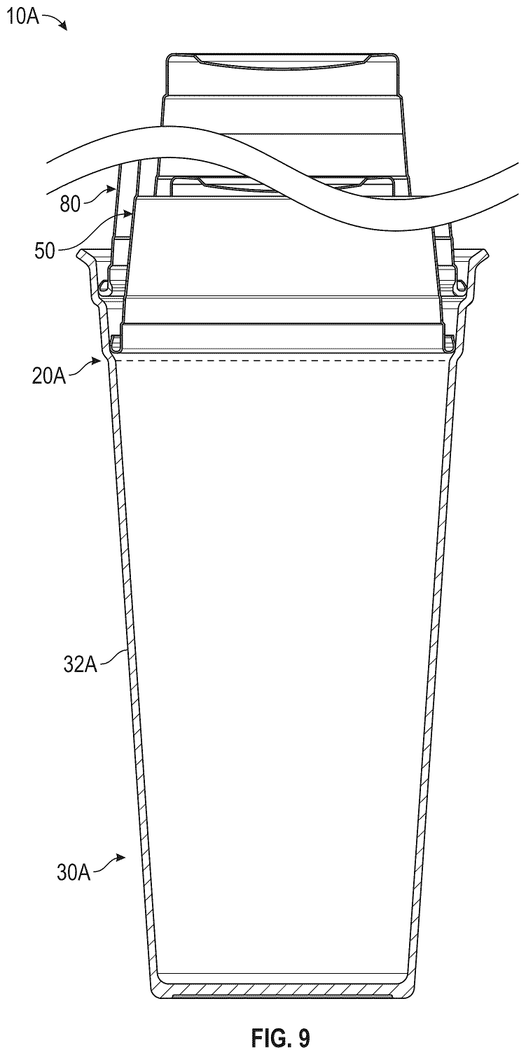

FIG. 7 illustrates another embodiment of a shaker cup 10A. FIG. 8 illustrates a side view of the shaker cup 10A of FIG. 7. FIG. 9 illustrates a shaker cup and beverage cup assembly. FIG. 9 shows the embodiment of the shaker cup 10A of FIGS. 7-8 used as a shaker cup with serving cups 50, 80. Some of the features of the shaker cup 10A are similar to features of the shaker cup 10 in FIGS. 1-6. Thus, reference numerals used to designate the various components of the shaker cup 10A are identical to those used for identifying the corresponding components of the shaker cup 10 in FIGS. 1-6, except that an “A” has been added to the numerical identifier. Therefore, the structure and description for the various features of the shaker cup 10 in FIGS. 1-6 are understood to also apply to the corresponding features of the liner 10A in FIGS. 7-9, except as described below.

The shaker cup 10A differs from the shaker cup 10 in that the outer rim 22A of the open end of the top portion 20A of the cup 10A has a flange or lip. The lip can extend around or define the outer circumferential edge of the opening of the top portion 20A of the cup 10A. The lip can extend radially such that the lip defines an outer circumferential edge of the opening of the shaker cup 10A. The lip can extend in a radial direction from the outer circumferential edge of the top portion 20A of the cup 10A. In some examples, the lip or flange can extend radially or have a width of at least between 2 mm and 4 mm and in some embodiments at least 3 mm. In some examples, the height or thickness of the flange or lip can be at least between 2 mm and 4 mm and in some embodiments at least 3 mm.

In some examples, the outer diameter of the rim 22A including the lip can be between 4 inches to 5 inches and in some embodiments between 4.2 inches to 4.6 inches. The inner diameter of the rim 22A can be between 4 inches to 5 inches, and in some embodiments between 4.0 inches to 4.2 inches. In some examples, the inner diameter of the first ridge 24A can be between 3.5 inches to 4 inches, and in some embodiments between 3.8 inches to 4 inches. In some examples, the inner diameter of the second ridge 26A can be between 3 inches to 4 inches, and in some embodiments between 3.4 inches to 3.8 inches. In some examples, the inner diameter of the top portion of the body 32A can be between 3 inches to 4 inches, and in some embodiments between 3.5 inches to 4 inches. In some examples, the overall length or height of the shaker cup 10A can be between 6 inches to 9 inches, and in some embodiments between 8 inches and 9 inches. In some examples, the height or length of the shaker cup 10A can be between 8 inches and 8.5 inches.

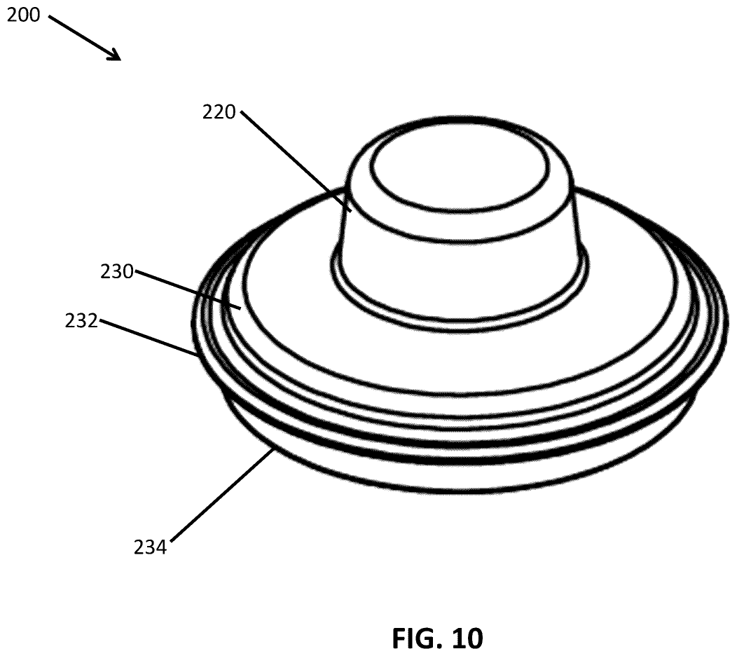

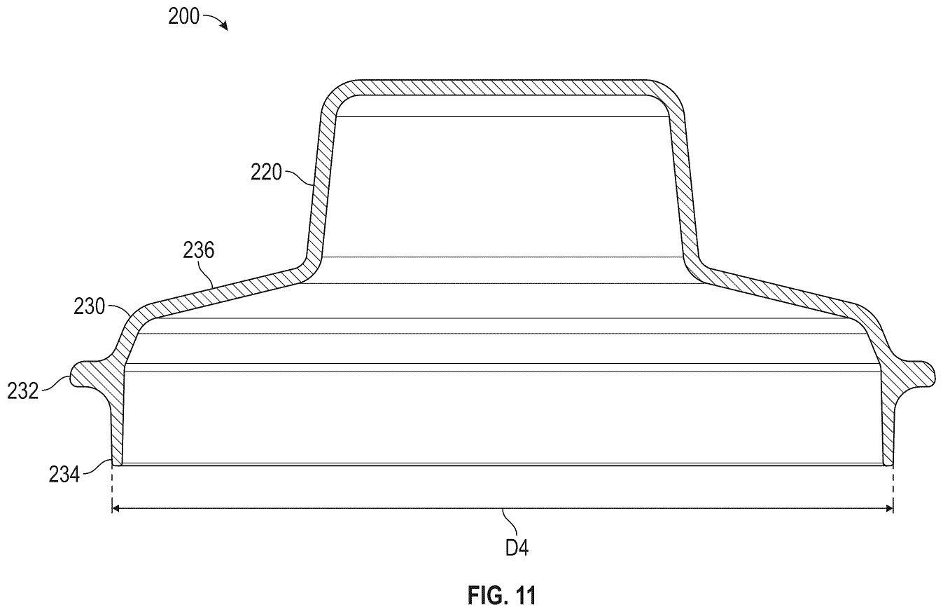

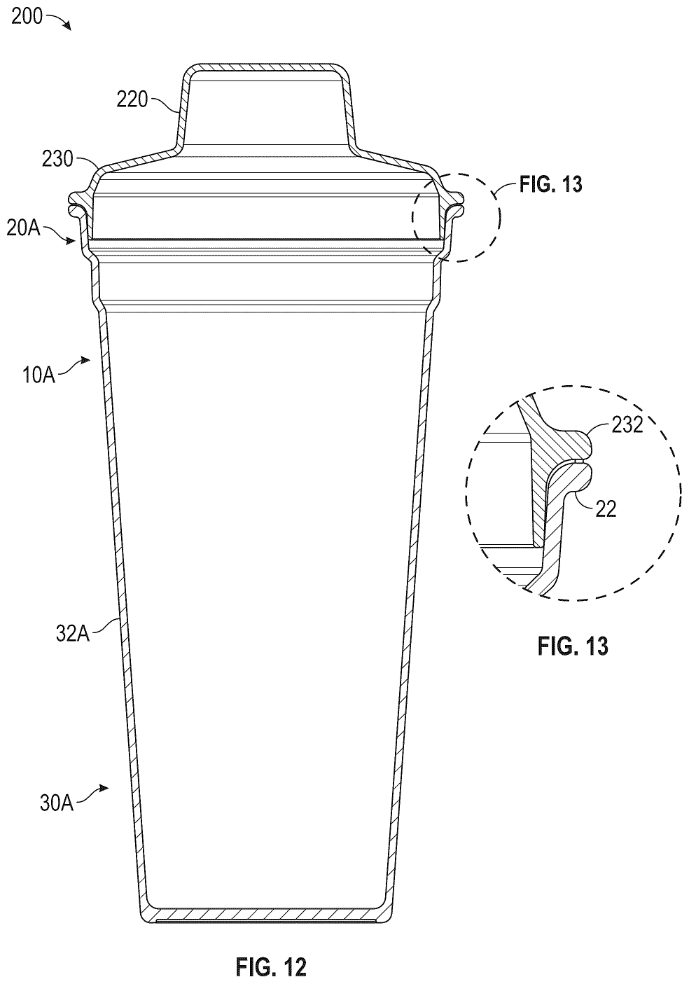

FIG. 10 illustrates a lid 200 that is configured to be used with a shaker cup. FIG. 11 illustrates a cross-sectional view of the lid of FIG. 10. FIG. 12 illustrates a cross-sectional view of the lid and shaker cup assembly. FIG. 13 illustrates a close up view of a portion of FIG. 12. In some examples, instead of using a serving cup as a top portion to close the opening of the shaker cup, the lid 200 can be used. This advantageously allows the shaker cup to be used in other configurations, such as without the serving cup. The lid 200 can include a handle 220 at a top portion of the lid 200 and a base 230 at a bottom portion of the lid 200. The handle 220 can be configured to be gripped by a user to position the lid 200, such as sealing the lid 200 to a shaker cup or unsealing the lid 200 from the shaker cup. The handle 220 can be knob shaped or another shape that conveniently allows a user to grip and maneuver the handle 220. The handle 220 can extend from the base 230 in a proximal direction. The base 230 can have a dome shape. The base 230 can include a projection or skirt 232 that extends from an outer surface of the base 230. The projection or skirt 232 can extend radially from an outer circumferential surface of the base 230. The projection or skirt 232 can be positioned along a central portion of the outer surface of the base 230. The top or proximal portion 236 of the base 230 can be positioned above or be located proximally from the projection or skirt 232. The bottom or distal end 234 of the base 230 can be positioned below or be located distally from the projection or skirt 232. The bottom or distal end 234 include a circumferential wall. The base 230 can be hollow such the base 230 defines an interior recess, which can increase the interior space of the assembly for the beverage to be shaken. In some examples, the handle 220 can also be hollow and define an interior recess. The interior recess of the handle 220 can be connected to the interior recess of the base 230.

In some examples, the lid 200 can be configured to fit with the shaker cup 10 of FIGS. 1-3. In some examples and as illustrated in FIG. 12, the lid 200 can be configured to fit with the shaker cup 10A of FIGS. 7-8. The bottom or distal end 234 of the base 230 can have an outer diameter H4 that is configured to fit within the opening of the shaker cup 10A. The outer diameter H4 can be between 5 inches and 3 inches, for example, between 3.5 and 4.25 inches. The projection or skirt 232 can have a larger outer diameter than the bottom end 234 of the base 230. The projection or skirt 232 can have at least the same size diameter as the outer diameter of the open end of the shaker cup 10A. The projection or skirt 232 can be configured to be positioned against the lip of the rim 22A of the shaker cup 10A. In this manner, the projection or skirt 232 can facilitate the seal of the lid 200 and the cup 10A.

As shown in FIG. 12, the lid 200 can be affixed to a top of a shaker cup 10A to create a seal. The cup 10A, when closed with the lid 200, can then be shaken to prepare the drink. The lid 200 can be removed from the cup 10A. The lid 200 can fit within a mouth or opening of the cup 10A such that at least part of the distal end 234 of the lid 200 can fit within the cup 10A. The lid 200 can act as a plunger inside the cup 10A to seal the cup 10A for shaking. The material of the lid 200 can facilitate the sealing of the lid 200 with the cup 10A. The material can be soft to allow for both a face seal and a radial seal with the lid 200 and the cup 10A.

The configuration of the lid 200 provides both a face seal and a radial seal. For example, as shown in FIG. 12, when the distal end 234 fits into an opening of the shaker cup 10A of a corresponding diameter, the outer circumferential surface of the distal end 234 can form a radial seal with the inner surface of the opening of the cup 10A. Additionally, the bottom or distal surface of the projection or skirt 232 can form a face seal with the top surface of the lip of the rim 22A of the cup 10A. The projection or skirt 232 can also prevent the lid 200 from being pushed too far into the opening of the shaker cup 10A.

In some examples, the distal end 234 can be made of a material that can facilitate sealing. For example, the material can be soft enough to provide a snug fit within the opening of a cup. In some examples, the distal end 234 can be made of silicone or another type of elastomer. The remainder of the lid 200 can be made of the same material. The remainder of the lid 200 or at least the handle 220 can be made of a stiffer material, such as metal or plastic.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### Summary

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A shaker cup, comprising:
a body defining a first interior;
a rim defining an opening;
a first ridge of a first ridge diameter positioned below the rim, the first ridge configured to receive a first serving cup of a first size; and
a second ridge of a second ridge diameter positioned below the first ridge, the second ridge configured to receive a second serving cup of a second size;
wherein the first ridge diameter is larger than the second ridge diameter.

2. The shaker cup of claim 1, wherein the first ridge comprises a first planar surface that is concentric to the rim, wherein the second ridge comprises a second planar surface that is concentric to the first ridge.

3. The shaker cup of claim 2, further comprising a first sidewall positioned between the rim and the first ridge, a second sidewall positioned between the first ridge and the second ridge.

4. The shaker cup of claim 3, wherein the first planar surface of the first ridge is configured to extend at a first angle relative to the first sidewall, wherein the second planar surface of the second ridge is configured to extend at a second angle relative to the second sidewall, wherein the first angle and the second angle are each between 90 degrees to 145 degrees.

5. The shaker cup of claim 3, wherein the first sidewall is configured to form a first radial seal with the first serving cup, wherein the second sidewall is configured to form a second radial seal with the second serving cup.

6. The shaker cup of claim 2, wherein the first planar surface is configured to form a first face seal with the first serving cup, wherein the second planar surface is configured to form a second face seal with the second serving cup.

7. The shaker cup of claim 1, wherein the first ridge diameter of the first ridge is configured to receive a first cup diameter of the first serving cup.

8. The shaker cup of claim 1, wherein the second ridge diameter of the second ridge is configured to receive a second cup diameter of the second serving cup.

9. The shaker cup of claim 1, wherein the first ridge and the second ridge are configured to form a stepped profile.

10. The shaker cup of claim 1, further comprising a third ridge of a third ridge diameter positioned below the second ridge, wherein the third ridge diameter is smaller than the second ridge diameter of the second ridge.

11. The shaker cup of claim 1, wherein the rim comprises a lip that extends radially such that the lip defines an outer circumferential edge of the opening of the shaker cup.

12. A shaker cup and serving cup assembly, comprising:
a shaker cup comprising:
a body defining a first interior,
a rim defining an opening,
a first ridge of a first ridge diameter positioned below the rim, and
a second ridge of a second ridge diameter positioned below the first ridge,
wherein the first ridge diameter is larger than the second ridge diameter;
a first serving cup of a first size; and
a second serving cup of a second size,
wherein the first size and the second size are different,
wherein the first ridge of the shaker cup is configured to receive the first serving cup,
wherein the second ridge of the shaker cup is configured to receive the second serving cup.

13. The shaker cup and serving cup assembly of claim 12, wherein the first serving cup is configured to be inverted such that an open end of the first serving cup is positioned below a closed end of the first serving cup when the first serving cup is received by the shaker cup.

14. The shaker cup and serving cup assembly of claim 12, wherein the shaker cup comprises a first material, wherein the first serving cup and the second serving cup comprises a second material, wherein the first material is more rigid than the second material.

15. A method for preparing a beverage, the method comprising:
placing one or more ingredients in a shaker cup;
positioning a first serving cup of a first size or a second serving cup of a second size on top of the shaker cup to seal the shaker cup, wherein the first size is different from the second size;
shaking the shaker cup and the first or second serving cup together;
removing the shaker cup from the first or second serving cup; and
serving the beverage in the first or second serving cup.

16. The method of claim 15, further comprising positioning the first serving cup in an inverted position when the first serving cup is received by the shaker cup, wherein, in the inverted position, an open end of the serving cup is positioned beneath a closed end of the serving cup.

17. The method of claim 16, wherein shaking the shaker cup and the first or second serving cup together comprises positioning the shaker cup in an upright position and the first or second serving cup in an inverted position.

18. The method of claim 15, further comprising inverting the shaker cup and the first or second serving cup together such that the shaker cup is in an inverted position and the first or second serving cup is in an upright position.

19. The method of claim 15, further comprising placing a lid on the first or second serving cup.

20. The method of claim 15, wherein shaking the shaker cup and the first or second serving cup together comprises forming a foam head with a height between 0.25 inches to 2 inches.
